(19) United States
(12) Patent Application Publication
(10) Pub. No.: US 2015/0301725 A1
(43) Pub. Date: Oct. 22, 2015

(54) CREATING MULTIMODAL OBJECTS OF USER RESPONSES TO MEDIA

(71) Applicants: Sriganesh MADHVANATH, (US); Ramadevi VENNELAKANTI, (US); Prasenjit DEY, (US); HEWLETT-PACKARD DEVELOPMENT COMPANY, L.P, Houston, TX (US)

(72) Inventors: Sriganesh Madhvanath, Bangalore (IN); Ramadevi Vennelakanti, Bangalore (IN); Prasenjit Dey, Bangalore (IN)

(21) Appl. No.: 14/648,950

(22) PCT Filed: Dec. 7, 2012
(86) PCT No.: PCT/IN2012/000800

§ 371 Date: Jun. 2, 2015

(51) Int. Cl. G06F 3/0484

(52) U.S. Cl. CPC G06F 3/04845; G06F 3/04842

(57) ABSTRACT

Creating a multimodal object of a user response to a media object can include capturing a multimodal user response to the media object, mapping the multimodal user response to a file of the media object, and creating a multimodal object including the mapped multimodal user response and the media object.

### BACKGROUND

People can view media, such as photographs, video, and television content on a variety of devices, both individually and in social settings. Responses to the viewed media can be multimodal in nature. For instance, responses to media can include facial gestures, hand gestures, speech, and non-speech sounds.

### BRIEF DESCRIPTION OF THE DRAWINGS

FIG. 1 is a flow chart illustrating an example of a process for creating a multimodal object of a user response to a media object according to the present disclosure.

FIG. 2 illustrates an example of a multimodal object according to the present disclosure.

FIG. 3 is a block diagram illustrating an example of a method for creating a multimodal object of a user response to a media object according to the present disclosure.

FIG. 4 illustrates an example of a system including a computing device according to the present disclosure.

### DETAILED DESCRIPTION

Consumer responses to media, such as a media object, can be useful for a variety of purposes. For instance, captured responses can be shared with others (e.g., friends and family) who are remotely located, can be used to identify what advertisers to associate with a particular media object, and/or can be used to determine an effectiveness of a media object (e.g., positive reaction to an advertisement).

Media and/or media objects can be viewed and/or packaged in a number of ways. For instance, Internet media sites (e.g., YouTube and Flicker) and social network sites (e.g., Facebook, Twitter, and GooglePlus) allow users (e.g., consumers) to comment on media objects posted by others. The comments tend to be textual in nature and can be studied responses instead of spontaneous responses and/or interactions. Such textual responses, for example, tend to be limited in emotional content.

In some instances, a real-time camera-based audience measurement system can be used to understand how an online and/or road billboard advertisement is being received. Such systems can count how many people have viewed the billboard and potentially analyze the demographics of viewers.

Further, video screen capture, sometimes referred to as screencast, can contain audio narration based off of a digital recording of a computer screen output. Screencasts can be used to demonstrate and/or teach the use of software features, in education to integrate technology into curriculum, and for capturing seminars and/or presentations. Screencasts tend to capture purposeful screen activity and audio narration of the presenter, rather than spontaneous responses of the viewers.

However, internet media sites and social network sites, real-time camera-based audience measurement systems, and video screen captures tend to be limited as they cannot capture multiple aspects of the user response such as the tone of a response, a gesture of a user's face and/or head, and/or something that is pointed to in the media object. In contrast, examples in accordance with the present disclosure can be used to capture and format a multimodal user response to a media object as the response occurs. The resulting multimodal user response can, for instance, be a real-time user response including multiple modalities of the response.

Examples of the present disclosure may include methods, systems, and computer-readable and executable instructions and/or logic. An example method for creating a multimodal object of a user response to a media object can include capturing a user response to the media object, mapping the user response to a file of the media object, and creating a multimodal object including the mapped user response and the media object.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and the process, electrical, and/or structural changes may be made without departing from the scope of the present disclosure.

The figures herein follow a numbering convention in which the first digit or digits correspond to the drawing figure number and the remaining digits identify an element or component in the drawing. Similar elements or components between different figures may be identified by the use of similar digits. Elements shown in the various examples herein can be added, exchanged, and/or eliminated so as to provide a number of additional examples of the present disclosure.

In addition, the proportion and the relative scale of the elements provided in the figures are intended to illustrate the examples of the present disclosure, and should not be taken in a limiting sense. As used herein, the designators “N” and “P” particularly with respect to reference numerals in the drawings, indicate that a number of the particular feature so designated can be included with a number of examples of the present disclosure. Also, as used herein, “a number of” an element and/or feature can refer to one or more of such elements and/or features.

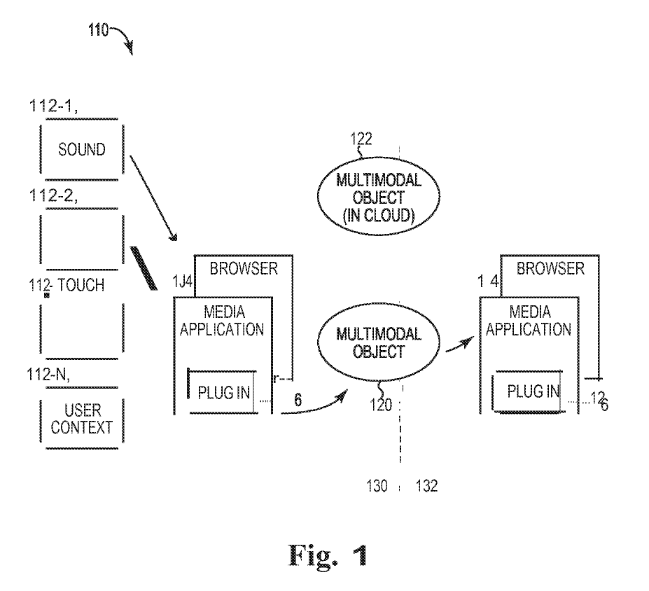

FIG. 1 is a flow chart illustrating an example of a process 110 for creating a multimodal object of a user response to a media object according to the present disclosure. A media object, as used herein, can be a file of a video, audio (e.g., music and/or speech), photograph, slideshow of photographs, and/or a document, among many other files. A user can include a consumer, a viewing user, and/or an associated user (e.g., friend, family member, and/or co-worker of the creator of the media object), among many other people that may view a media object.

A user can view a media object on a computing device 130. For instance, the computing device 130 can include a browser 118 and/or a media application 114. The media application 114 can run on a computing device 130, for example. A browser 118 can include an application (e.g., computer-executable instructions) for retrieving, presenting, and traversing information resources (e.g., domains, images, video, and/or other content) on the Internet. The media application 114 can include a native and/or a non-native application. A native application can include an application (e.g., computer-readable instructions) that operates under the same operating system and/or operating language as the computing device.

A non-native application can include an application (e.g., computer-readable instructions) that is web-based (e.g., operating language is a browser-rendered language, such as Hyper Text Markup Language combined with JavaScript) and/or not developed for a particular operating system (e.g., Java application and/or a browser 118). A non-native application and/or native application 114 may use a plug-in 116, in some instances, to support creation and/or playback of a multimodal object 120 from media objects stored locally. A plug-in 116, as used herein, can include computer-executable instructions that enable customizing the functionality of an application (e.g., to play a media object, access components of the computing device 130 to create a multimodal object 120, and/or playback the multimodal object 120).

The media object can, for instance, be stored locally on the computing device 130 of the user and/or can be stored externally. For instance, a media object can be stored externally in a cloud system, a social media network, and/or many other external sources and/or external systems. A media object stored on an external source and/or system can be accessed and/or viewed by the user using the browser 118 and/or the Internet, for example.

The process 110 can include capturing a user response to a media object. A user response, as used herein, can include a reaction and/or interaction of the user to viewing the media object.

A user response can include a multimodal user response. A modality, as used herein, can include a particular way for information to be presented and/or communicated to and/or by a human. A multimodal user response can include multiple modalities of responses by a user.

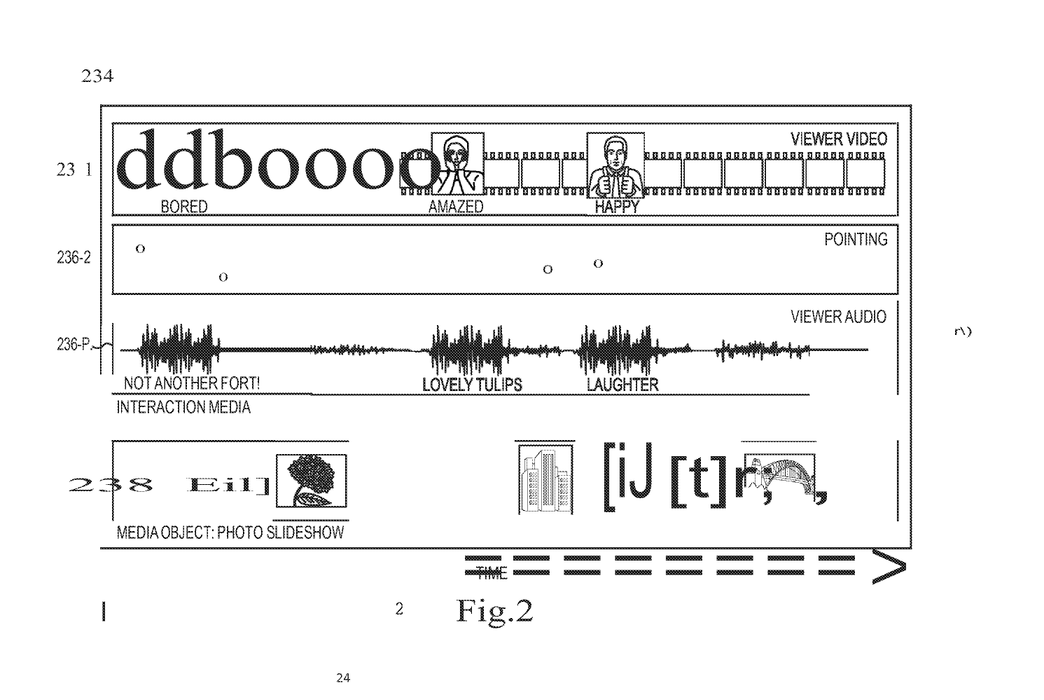

For instance, as illustrated in the example of FIG. 1, multiple modalities of user responses can include sound 112-1, gestures 112-2, touch 112-3, user context 112-N, and/or other responses. Sound 112-1 can include words spoken, laughter, sighs, and/or other noises. Gestures 112-2 can include hand gestures, face gestures, head gestures, and/or other body gestures of the user. Touch 112-3 can include point movements (e.g., as discussed further in FIG. 2), among other movements. User context 112-N can, for instance, include a level of attention, an identity of the user, and/or facial expression of the viewing user, among other context.

The multimodal user responses 112-1, 112-2, 112-3, . . . , 112-N can be captured using a computing device 130 of the user. For instance, the multimodal user responses 112-1, . . . , 112-N can be captured using a native and/or non-native application (e.g., media application 114 and/or browser 118), a plug-in 116, a camera, a microphone, a display, and/or other hardware and/or software components (e.g., computer-executable instructions) of the user computing device 130. The captured user responses can include user response data.

The captured multimodal user responses can, in some examples of the present disclosure, be user configurable. For instance, a user can be provided a user-configurable selection of types of user response data to capture prior to capturing the multimodal user responses and/or viewing the media object. The user-configurable selection can be provided in a user interface. For instance, the user interface can include a display allowing a user to select the types of user responses to capture. The modalities of user responses captured can be in response to the user selection.

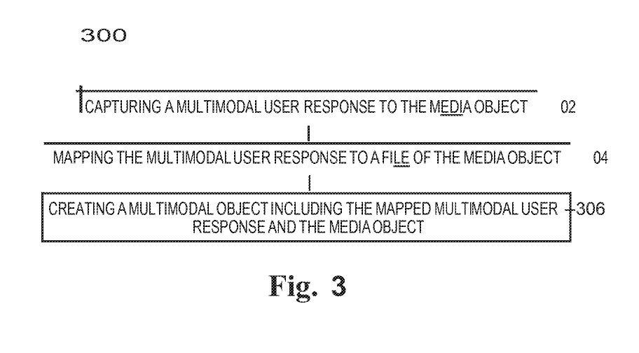

The captured multimodal user responses can be mapped to a file of the media object based on a common timeline. The common timeline, as used herein, can include the timeline of the media object. For example, mapping the multimodal user responses can include processing and/or converting the user responses into sub-portions, annotating the processed responses with reference to a time and/or place in the media object, and mapping each sub-portion of the user responses to the time and/or place in the media object (e.g., as discussed further in FIG. 3).

Using the mapped user responses, a multimodal object 120 can be created. The multimodal object 120 can include the mapped user responses and the media object. For instance, the multimodal object 120 can be a multilayer multimodal object. A multilayer multimodal object can include each modality of the user's responses 112-1, . . . , 112-N and the media object on a separate layer of the multilayer multimodal object.

In various examples of the present disclosure, the media object can be stored externally (e.g., in a cloud system). A media object stored externally can be used and/or viewed to create a multimodal object 122 using a browser 118 and a plug-in 116. A user can grant the plug-in 116 permission to access components of the user computing system 130 to capture user response data and/or create a multimodal object 122. The multimodal object 122 created using a media object stored externally can include a link that can be shared, for example. For instance, the link can be embedded as a part of the multimodal object 122 and/or include an intrinsic attribute of the multimodal object 122.

In some examples of the present disclosure, a multimodal object 122 created using a media object stored externally can include a set of user response data. The set of user response data can include an aggregation of multiple users responses to the media object stored externally. The multimodal object 122 can accumulate and/or aggregate the multiple users' responses with the media object over time.

In various examples of the present disclosure, the set of user response data and/or a user response to the media object can include multiple co-present users' responses to the media object. Multiple co-present users can include multiple users viewing and/or interacting over media in a co-present manner. Co-present, as used herein, can include synchronously (e.g., viewing and/or interacting at a common time). In some examples, synchronously can include simultaneously. The multiple co-present users' responses to a media object can be shared, for example. For instance, the multiple co-present users' responses can be shared with an end-user and/or stored externally in an external system.

For instance, multiple co-present users can include a co-located group of users (e.g., multiple users located in the same location) and/or non co-located group of users (e.g., viewing at the same time using the Internet). Multiple users that are co-located can include a group of users located around a system sharing the media object. For instance, user response data captured from the multiple co-located users can be stored on an external system (e.g., a cloud system) and/or internal system (e.g., a device associated with the multiple users).

A non co-located group of users can view a media object on the Internet (e.g., a whiteboard application) while each user in the group is located at different points and/or locations. User response data from the multiple non co-located group of users can be aggregated automatically using an external system (e.g., aggregate in a cloud system as captured) and/or locally on each of the user's computing systems using the external system (e.g., synchronize each user's computing system and aggregate in the external system).

In some examples of the present disclosure, each response of a user, among a non co-located group of users, to a media object can be captured non-synchronously (e.g., asynchronously), and can be processed to and/or into a synchronous multimodal object. As an example, user A can be located at location I, user B can be located at location II, and user C can be located at location III. User A, user B, and user C can view the media object at their respective locations at separate and/or different times. Each user's response (e.g., user A, user B, and user C) can be captured at a computing device associated with the respective user and mapped to a file of the media object based on a common timeline (e.g., timeline of the media object). A multimodal object can be created on and/or use an external system (e.g., cloud system) by aggregating each mapped user response to the file of the media object to create a multiuser multimodal object including each user's mapped multimodal user response and the media object.

The multimodal object created (e.g., multimodal object in a cloud 122 and/or multimodal object 120 internally stored) can be distributed to an end-user. Distribution can include sharing, sending, and/or otherwise providing the multimodal object to an end-user to be viewed. An end-user, as used herein, can include a creator of the media object (e.g., company, organization, and/or third-party to a company and/organization), a company and/or organization, a system (e.g., cloud system, social network, Internet, etc.), and/or many other persons that may benefit from viewing the multimodal object.

In various examples of the present disclosure, a multimodal object 122 created, stored, and/or accessed from an external system can track and/or aggregate responses to the media object and/or the multimodal media object from an external system user. An external system user can include a social network user, a cloud system user, and/or Internet user, among many other system users. The external system user can include a user on the external system the multimedia object 122 is created, stored, and/or accessed from a separate and/or different external system.

A multimodal object 122 stored on an external system (e.g., cloud system) can be accessed and/or viewed (e.g., played) by a number of end-users. For instance, a number of end-users that are located in a number of locations can view the multimodal object 122 on a number of devices. Each device among the number of devices can be associated with an end-user among the number of end-users. Further, if the media object is stored on the external system (e.g., a photograph shared on a photograph sharing site), it may be easier to capture multiple users' responses to create a multimodal object 122 than if the media object were stored on an internal system because the media object can be accessed by the number of end-users.

For instance, a multimodal object 122 created from a media object stored externally can include captured social network responses to the media object. The social network responses can be captured and incorporated into the media object. Social network responses and/or external system responses can include comments on the media object and can be treated as audio comments from a user, for example. In some examples, if the external system user has granted permission to access the external system user's computing device (e.g., webcam, microphone, etc.), a full multimodal response can be captured. If the external system user has not granted permission, text comments can be captured.

The distributed multimodal object 120, 122 can be viewed by the end-user. The end-user can view the multimodal object 120, 122 using a native and/or non-native media application 124, a plug-in 126, and/or a browser 128 on a computing device 132 of and/or associated with the end-user. Viewing the multimodal object 120, 122 can include a synchronous view of each layer of the multimodal object (e.g., the media object and each modality of the user response) based on a common timeline.

FIG. 2 illustrates an example of a multimodal object 234 according to the present disclosure. A multimodal object 234, as illustrated by FIG. 2, can include captured user response data. The captured user response data can include multiple layers. For instance, each layer 236-1, 236-2, . . . , 236-P, 238 can include one modality of a user response 236-1, . . . , 236-P and/or the file of the media object 238 based on a common timeline 240.

The multimodal object 234 can be viewed by an end-user on a user interface (e.g., a display). For instance, the multimodal object 234 can be viewed, displayed, and/or played back to the end-user in a synchronous view of each layer 236-1, . . . , 236-P, 238 of the multimodal object 234 to recreate the live interaction experience and/or response of the user.

A synchronous view can include display and/or play back of user response data captured (e.g., 236-1, . . . , 236-P) and/or processed with the media object (e.g., 238) playing at the same time. For instance, the media object 238 can be rendered in a separate window. Mouse and/or other forms of point movements can be superimposed as pointers on the media object itself 238 to represent where the user has pointed. Point movements, as used herein, can include user movements and/or pointing toward a display (e.g., screen, touch screen, and/or mobile device screen) while a media object is playing. The point movements can be accomplished by moving a mouse, touching a display, and/or pointing from a distance (e.g., sensed using a depth camera). The point movements can be in reference to a media object (e.g., a point of interest in the media object). The point movements captured can be represented in the created multimodal object as a separate layer 236-2 with the point movements represented by reference to a space on the media object pointed to.

In some examples, the user response data can be processed and/or converted to a text format and the text can be displayed. For instance, audio and/or other input modalities captured can be processed, converted, and/or displayed as subtitles and/or text at the bottom of the screen (e.g., as illustrated by the text “bored”, “amazed”, and “happy” of layer 236-1). The text can be displayed with added animation (e.g., virtual characters as illustrated in 236-1) and/or converted into other forms (e.g., synthesized laughter to represent laughing as illustrated in 236-P).

The user response data, in various examples, can be processed, converted, and/or displayed in sub-portions. For instance, the sub-portions can be represented as text and/or can include the actual sub-portions of the interaction data collected. The sub-portions, in some examples, can be processed in separate layers. The layers of modality 236-1, . . . , 236-P can each include video, audio, and/or screenshots of the user response (e.g., live pictures and/or video of the user responding to the video and/or live audio recordings), among other representations.

FIG. 3 is a block diagram illustrating an example of a method 300 for creating a multimodal object of a user response to a media object according to the present disclosure. At 302, the method 300 can include capturing a multimodal user response to the media object. The multimodal user response can be recorded using a camera, microphone, and/or other hardware and/or software (e.g., executable instruction) components of a computing device of and/or associated with the user. The captured multimodal user response can include user response data, for instance.

A multimodal user response to a media object can include multiple modalities of response. For example, response to media objects can include modalities such as facial gestures, hand gestures, speech sounds, and/or non-speech sounds.

At 304, the method 300 can include mapping the multimodal user response to a file of the media object. Mapping can, for instance, be based on a common timeline. For example, mapping can include annotating each multimodal user response to a media object with a reference to the media object. For instance, a user response to a media object can be annotated with reference to a particular time (e.g., point in time) in the media object that each response occurred and/or reference to a place in the media object (e.g., a photograph in a slideshow).

In some examples of the present disclosure, the captured multimodal user response data can be processed. For instance, the captured user response data can be converted to multiple sub-portions, to labels, and/or text. The multiple sub-portions can, for example, be used to remove silences (e.g., empty space in the user response data) in the user response to reduce storage space as compared to the complete user response data. The labels and/or text can be obtained and/or converted from the user response data using speech-to-text convertors, facial detection and facial expression recognition, and/or hand gesture interpreters, for instance. For instance, a face can be identified from a set of registered faces. The registered faces can include faces corresponding to frequent viewers (e.g., family and friends).

The converted sub-portions, labels, and/or text can be derived from the complete user response data and can be annotated with timestamps and/or references to a specific and/or particular place (e.g., photograph, time, and/or image) corresponding to when the sub-portion occurred with respect to the media object viewed.

As an example, a media object can include a photographic slideshow of two pictures. A user response to a first picture can be converted and/or processed to a first sub-portion (e.g., cut into a piece and/or snippet) and can be annotated with a reference to the first photograph. The user response to a second picture can be converted and/or processed to a second sub-portion and can be annotated with a reference to the second photograph. If the user does not have a response during viewing of the media object for a period of time (e.g., between the first photograph and the second photograph), the user response data containing no response can be removed from the captured user response data. Using the annotated references, the multimodal user response to the first picture can be mapped to the first picture and the multimodal user response to the second picture can be mapped to the second picture.

At 306, the method 300 can include creating a multimodal object including the mapped multimodal user response and the media object. The multimodal object can include a multilayer file of each modality of the user response data associated with the file of the media object. For instance, a multilayer file of each modality can include a file containing multiple channels of the user response data that can be layered and based on a common timeline (e.g., the timeline of the media object).

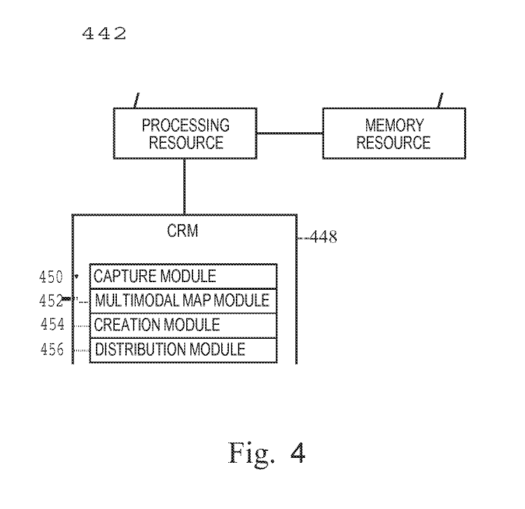

FIG. 4 illustrates an example of a system including a computing device 442 according to the present disclosure. The computing device 442 can utilize software, hardware, firmware, and/or logic to perform a number of functions.

The computing device 442 can be a combination of hardware and program instructions configured to perform a number of functions. The hardware, for example can include one or more processing resources 444, computer-readable medium (CRM) 448, etc. The program instructions (e.g., computer-readable instructions (CRI)) can include instructions stored on the CRM 448 and executable by the processing resources 444 to implement a desired function (e.g., capturing a user response to the media object, etc.).

CRM 448 can be in communication with a number of processing resources of more or fewer than 444. The processing resources 444 can be in communication with a tangible non-transitory CRM 448 storing a set of CRI executable by one or more of the processing resources 444, as described herein. The CRI can also be stored in remote memory managed by a server and represent an installation package that can be downloaded, installed, and executed. The computing device 442 can include memory resources 446, and the processing resources 444 can be coupled to the memory resources 446.

Processing resources 444 can execute CRI that can be stored on an internal or external non-transitory CRM 448. The processing resources 444 can execute CRI to perform various functions, including the functions described in FIGS. 1-3.

The CRI can include a number of modules 450, 452, 454, and 456. The number of modules 450, 452, 454, and 456 can include CRI that when executed by the processing resources 444 can perform a number of functions.

The number of modules 450, 452, 454, and 456 can be sub-modules of other modules. For example, the multimodal map module 452 and the creation module 454 can be sub-modules and/or contained within a single module. Furthermore, the number of modules 450, 452, 454, and 456 can comprise individual modules separate and distinct from one another.

A capture module 450 can comprise CRI and can be executed by the processing resources 444 to capture a multimodal user response to the media object. In some examples of the present disclosure, the multimodal user response can be captured using an application. The application can, for instance, include a native application, non-native application, and/or a plug-in. The multimodal user response can be captured using a camera, microphone, and/or other hardware and/or software components of a computing device of and/or or associated with the user. The native application and/or plug-in can request use of the camera and/or microphone, for example.

A multimodal map module 452 can comprise CRI and can be executed by the processing resources 444 to convert the multimodal user response into a number of layered sub-portions, annotate each layered sub-portion with a reference to the media object, and map each layered sub-portion of the multimodal user response to a file of the media object based on a common timeline and the annotation to the media object. A layer can, for instance, include a modality of the multimodal user response and/or the file of the media object, for example.

A creation module 454 can comprise CRI and can be executed by the processing resources 444 to create a multimodal object including the mapped layered user response and the media object. In some examples, the creation module 454 can include instructions to aggregate multiple users' responses to the media object. The multiple users can be co-present. For instance, the multiple users' responses can be synchronous (e.g., users are co-located and/or viewing the media object in a synchronized manner) and/or asynchronous (e.g., users are non co-located, viewing the media object at different times, and/or the aggregation can occur using an external system).

A distribution module 456 can comprise CRI and can be executed by the processing resources 444 to send the multimodal object to an end-user. For instance, the end-user can include a company and/or organization, a third party to the company and/or organization, a viewing user (e.g., family and/or friend of the user), and/or a system (e.g., a cloud system, a social network, and a social media site). The distribution module 456 can, in some examples, include instructions to store and/or upload the multimodal object to an external system (e.g., cloud system and/or social network). In such examples, the media object may be stored on the external system, in addition to the multimodal object.

In some examples, a system for creating a multimodal object of a user response to a media object can include a display module. A display module can comprise CRI and can be executed by the processing resources 444 to display the multimodal object using a native application and/or a plug-in of the computing device of and/or associated with the end-user. The multimodal object can be sent, for instance, to the end-user. The end-user can playback and/or view a received multimodal object. The playback and/or view can include a synchronous view and/or display of each layer of the multimodal object based on the common timeline. Each layer can include a modality of the user interaction data which can be displayed as text, sub-titles, animation, real audio and/or video, synthesized audio, among many other formats.

A non-transitory CRM 448, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, and/or a solid state drive (SSD), etc., as well as other types of computer-readable media.

The non-transitory CRM 448 can be integral, or communicatively coupled, to a computing device, in a wired and/or a wireless manner. For example, the non-transitory CRM 448 can be an internal memory, a portable memory, a portable disk, or a memory associated with another computing resource (e.g., enabling CRIs to be transferred and/or executed across a network such as the Internet).

The CRM 448 can be in communication with the processing resources 444 via a communication path. The communication path can be local or remote to a machine (e.g., a computer) associated with the processing resources 444. Examples of a local communication path can include an electronic bus internal to a machine (e.g., a computer) where the CRM 448 is one of volatile, non-volatile, fixed, and/or removable storage medium in communication with the processing resources 444 via the electronic bus.

The communication path can be such that the CRM 448 is remote from the processing resources, (e.g., processing resources 444) such as in a network connection between the CRM 448 and the processing resources (e.g., processing resources 444). That is, the communication path can be a network connection. Examples of such a network connection can include a local area network (LAN), wide area network (WAN), personal area network (PAN), and the Internet, among others. In such examples, the CRM 448 can be associated with a first computing device and the processing resources 444 can be associated with a second computing device (e.g., a Java® server). For example, a processing resource 444 can be in communication with a CRM 448, wherein the CRM 448 includes a set of instructions and wherein the processing resource 444 is designed to carry out the set of instructions.

As used herein, “logic” is an alternative or additional processing resource to perform a particular action and/or function, etc., described herein, which includes hardware (e.g., various forms of transistor logic, application specific integrated circuits (ASICs), etc.), as opposed to computer executable instructions (e.g., software, firmware, etc.) stored in memory and executable by a processor.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for creating a multimodal object of a user response to a media object, comprising:
capturing a multimodal user response to the media object;
mapping the multimodal user response to a file of the media object; and
creating the multimodal object including the mapped multimodal user response and the media object.

2. The method of claim 1, including converting the multimodal user response to the media object to multiple sub-portions of the multimodal user response.

3. The method of claim 1, wherein capturing the multimodal user response to the media object includes using a browser on a computing device.

4. The method of claim 1, wherein capturing the multimodal user response to the media object includes using a media application on a computing device.

5. The method of claim 1, wherein capturing the multimodal user response includes capturing multiple co-present users' responses to the media object.

6. The method of claim 5, wherein capturing the multiple co-present users' responses to the media object includes aggregating each user response among the multiple co-present users' responses to the media object using an external system.

7. The method of claim 1, including requesting access to a component of a computing device of the user to capture the multimodal user response.

8. A non-transitory computer-readable medium storing a set of instructions executable by a processing resource, wherein the set of instructions can be executed by the processing resource to:
capture a multimodal user response to a media object;
annotate the captured multimodal user response with a reference to the media object;
map the multimodal user response to a file of the media object based on a common timeline and the annotation to the media object; and
create a multimodal object including the mapped multimodal user response and the media object.

9. The non-transitory computer-readable medium of claim 8, wherein the instructions executable by the processing resource include instructions to aggregate multiple multimodal user responses to the media object in the multimodal object.

10. The non-transitory computer-readable medium of claim 8, wherein the instructions executable by the processing resource include instructions to capture a response of an external system user to the media object and incorporate the response in the multimodal object.

11. The non-transitory computer-readable medium of claim 8, wherein the instructions executable by the processing resource include instructions to provide a user-configurable selection of types of user response data to capture.

12. A system for creating a multimodal object of a user response to a media object comprising:
a processing resource;
a memory resource coupled to the processing resource to implement:
a capture module including computer-readable instructions stored on the memory resource and executable by the processing resource to capture a multimodal user response to the media object;
a multimodal map module including computer-readable instructions stored on the memory resource and executable by the processing resource to:
convert the multimodal user response into a number of layered sub-portions;
annotate each layered sub-portion with a reference to the media object; and
map each layered sub-portion of the multimodal user response to a file of the media object based on a common timeline and the annotation to the media object;
a creation module including computer-readable instructions stored on the memory resource and executable by the processing resource to create the multimodal object including the mapped layered user response and the media object; and
a distribution module including computer-readable instructions stored on the memory resource and executable by the processing resource to send the multimodal object to an end-user.

13. The system of claim 12, wherein the distribution module includes instructions to upload the multimodal object to an external system.

14. The system of claim 12, wherein the system includes a display module including computer-readable instructions stored on the memory resource and executable by the processing resource to display the multimodal object using a native application.

15. The system of claim 12, the system includes a display module including computer-readable instructions stored on the memory resource and executable by the processing resource to display the multimodal object to the end-user, wherein the display includes asynchronous view of each layer of the multimodal object based on the common timeline.
